(19) United States
(12) Patent Application Publication
(10) Pub. No.: US 2026/0353294 A1
(43) Pub. Date: Nov. 5, 2026

(54) LP-WUS-BASED BURSTY DATA EXCHANGE

(71) Applicant: InterDigital Patent Holdings, Inc., Wilmington, DE (US)

(72) Inventors: Faris Alfarhan, Montreal (CA); Chia-Hung Wei, Chesterbrook, PA (US); Samuli Turtinen, Ii (FI); Martino Freda, Laval (CA); Paul Marinier, Brossard (CA); Tuong Hoang, Montreal (CA); Ghyslain Pelletier, Montreal (CA); Brian Martin, Farnham (GB)

(73) Assignee: InterDigital Patent Holdings, Inc., Wilmington, DE (US)

(21) Appl. No.: 19/198,891

(22) Filed: May 5, 2025

(51) Int. Cl. H04W 52/02; H04W 52/24

(52) U.S. Cl. CPC H04W 52/0235; H04W 52/028; H04W 52/242

(57) ABSTRACT

A method may be implemented by a wireless transmit/receive unit (WTRU), and may include receiving, using a low-power radio, a configuration. The configuration may include one or more properties associated with an uplink low power wake-up signal (UL LP-WUS). It may be determined that a serving cell is operating in a power saving configuration. The UL LP-WUS may be sent, via the low power radio, using a selected property of the one or more properties indicated in the configuration. The UL LP-WUS may indicate one or more of a scheduling request, a volume of uplink data, a coverage condition, or a channel measurement condition. One or more of a scheduling grant or timing advance information may be received, in response to the UL LP-WUS. Uplink data may be sent using a main radio based on one or more of the scheduling grant or the timing advance information.

### BACKGROUND

Low power wake-up signal (LP-WUS) have been introduced in NR Release 19 as downlink (DL) signaling to wake up a wireless transmit/receive unit (WTRU) in IDLE and/or INACTIVE mode, but may also be supported for CONNECTED mode. LP-WUS may be based on On-Off Keying (OOK) and orthogonal frequency-division multiplexing (OFDM)-based wake-up receiver (WUR). The WTRU may implement a low power WUR (LP-WUR) as a separate receiver and/or may use the same main radio (MR) receiver. A LP-WUS occasion (LO) defined for LP-WUS monitoring may include one or more LP-WUS monitoring occasions (MO). In IDLE mode, a downlink LP synchronization signal (LP-SS) may be transmitted and may be used for the purpose of LP-WUR synchronization and radio resource management (RRM) measurements for a serving cell. LP-WUR may also be able to use existing primary synchronization signals (PSS) and/or secondary synchronization signals (SSS) for this purpose.

### SUMMARY

A wireless transmit/receive unit (WTRU) may be described herein. The WTRU may include a low-power radio, a main radio, and a processor. The processor may be configured to receive, using the low-power radio, a configuration. The configuration may include one or more properties associated with an uplink low power wake-up signal (UL LP-WUS). The processor may be configured to determine that a serving cell is operating in a power saving configuration. The processor may be configured to transmit, via the low-power radio, the UL LP-WUS using a selected property of the one or more properties indicated in the configuration. The UL LP-WUS may indicate one or more of a scheduling request, a volume of uplink data, a coverage condition, or a channel measurement condition. The processor may be configured to receive, in response to the UL LP-WUS, one or more of a scheduling grant or timing advance information. The processor may be configured to send, using the main radio, uplink data based on one or more of the scheduling grant or the timing advance information.

The processor may be configured to receive the configuration via dedicated signaling or broadcast signaling.

The processor may be configured to determine that the serving cell is operating in the power saving configuration based on reception of one or more of system information, a physical broadcast channel (PBCH), downlink control information (DCI), a medium access control (MAC) control element (CE), or a downlink low power wake-up signal (DL LP-WUS).

The one or more properties may include any combination of a time occasion associated with the UL LP-WUS, a frequency allocation associated with the UL LP-WUS, a subgroup associated with the UL LP-WUS, a sequence type or length associated with encoding of the UL LP-WUS, or a sequence or radio network temporary identifier (RNTI) used to scramble the UL LP-WUS.

The processor may be configured to select the selected property as a function of one or more of a measured channel condition, a size of the uplink data, or a data flow associated with the uplink data.

The processor may be configured to transmit the UL LP-WUS using a transmit power based on a downlink pathloss estimate. The downlink pathloss estimate may be determined based on reception of one or more of a downlink synchronization signal, a low power synchronization signal, an on-demand signal, or a cell discovery signal. The UL LP-WUS may include a signal transmitted by reflecting or modulating a downlink signal received by the low-power radio.

The processor may be configured to temporarily activate the main radio for transmission of the uplink data and return to a power saving configuration after transmission of the uplink data is complete.

The uplink data may be sent using a configured or dynamically scheduled resource. The configured or dynamically scheduled resource may be valid for a cell that shares one or more of a configuration area or timing advance group with the serving cell.

The configuration may include a plurality of power saving configurations. The processor may be configured to select one of the configurations based on one or more of a volume of the uplink data, a latency associated with the uplink data, or a timing advance validity condition.

The configuration may include one or more of information about a plurality of partitions, a reference signal received power (RSRP) range or a condition that the RSRP is less than a configured threshold, a level or range of measured channel state information (CSI) or channel quality indicator (CQI), or one or more data flows. Each partition may be associated with a minimum size or a size range associated with uplink data. The processor may be configured to send the UL LP-WUS based on a partition of the plurality of partitions.

A method may be implemented by a wireless transmit/receive unit (WTRU), and may include receiving, using a low-power radio, a configuration. The configuration may include one or more properties associated with an uplink low power wake-up signal (UL LP-WUS). It may be determined that a serving cell is operating in a power saving configuration. The UL LP-WUS may be sent, via the low power radio, using a selected property of the one or more properties indicated in the configuration. The UL LP-WUS may indicate one or more of a scheduling request, a volume of uplink data, a coverage condition, or a channel measurement condition. One or more of a scheduling grant or timing advance information may be received, in response to the UL LP-WUS. Uplink data may be sent using a main radio based on one or more of the scheduling grant or the timing advance information.

The method may include receiving the configuration via dedicated signaling or broadcast signaling.

The determining that the serving cell is operating in the power saving configuration may include detecting one or more of system information, a physical broadcast channel (PBCH), downlink control information (DCI), a medium access control (MAC) control element (CE), or a downlink low power wake-up signal (DL LP-WUS).

The one or more properties may include any combination of a time occasion associated with the UL LP-WUS, a frequency allocation associated with the UL LP-WUS, a subgroup associated with the UL LP-WUS, a sequence type or length associated with encoding of the UL LP-WUS, or a sequence or radio network temporary identifier (RNTI) used to scramble the UL LP-WUS.

The selected property may be selected as a function of one or more of a measured channel condition, a size of the uplink data, or a data flow associated with the uplink data.

The method may include sending the UL LP-WUS using a transmit power based on a downlink pathloss estimate. The downlink pathloss estimate may be determined based on reception of one or more of a downlink synchronization signal, a low power synchronization signal, an on-demand signal, or a cell discovery signal. The UL LP-WUS may include a signal transmitted by reflecting or modulating a downlink signal received by the low-power radio.

The method may include temporarily activating the main radio for sending the uplink data, and returning to a power saving configuration after the sending of the uplink data is complete.

The uplink data may be sent using a configured or dynamically scheduled resource. The configured or dynamically scheduled resource may be valid for a cell that shares one or more of a configuration area or timing advance group with the serving cell.

The configuration may include a plurality of power saving configurations. The method may include selecting one of the configurations based on one or more of a volume of the uplink data, a latency associated with the uplink data, or a timing advance validity condition.

The configuration may include one or more of information about a plurality of partitions, a reference signal received power (RSRP) range or a condition that the RSRP is less than a configured threshold, a level or range of measured channel state information (CSI) or channel quality indicator (CQI), or one or more data flows. Each partition may be associated with a minimum size or a size range associated with uplink data. The method may include selecting a partition of the plurality of partitions and sending the UL LP-WUS based on the selected partition.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram illustrating an example method for uplink data transmission by a wireless transmit/receive unit (WTRU) operating in a power saving configuration according to an embodiment.

### DETAILED DESCRIPTION

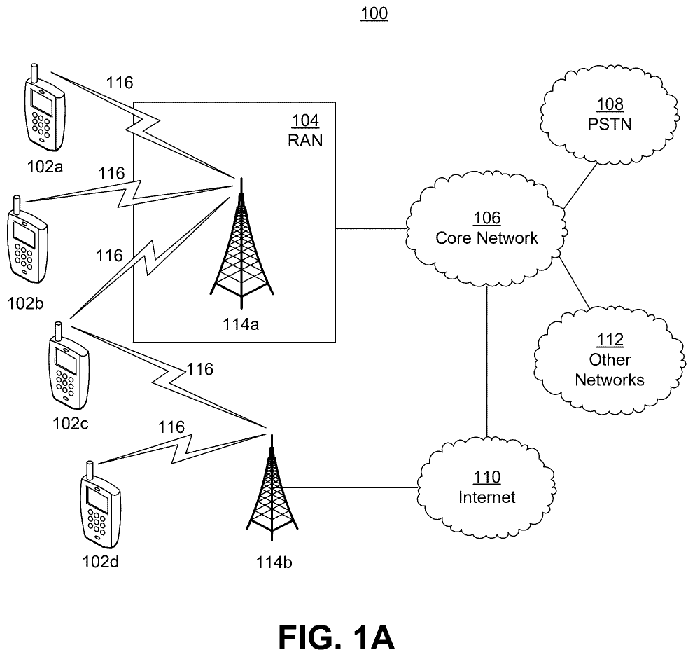

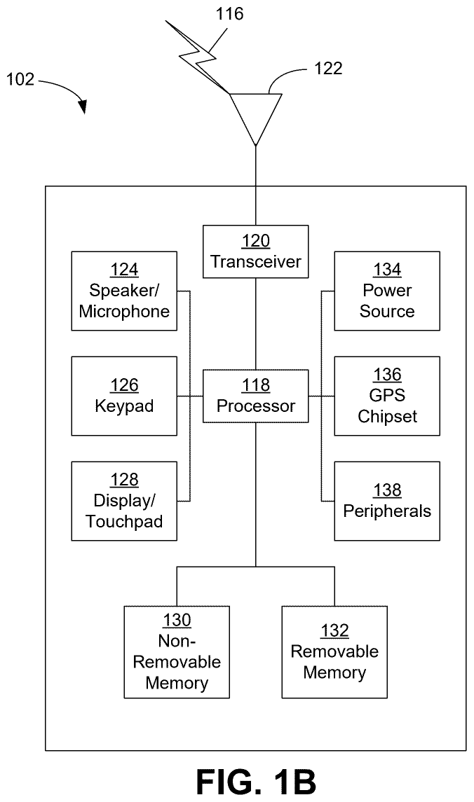

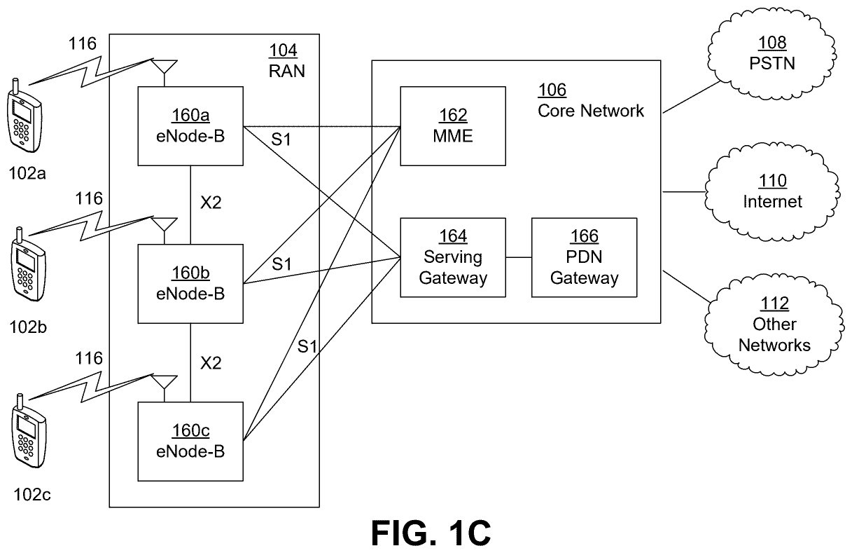

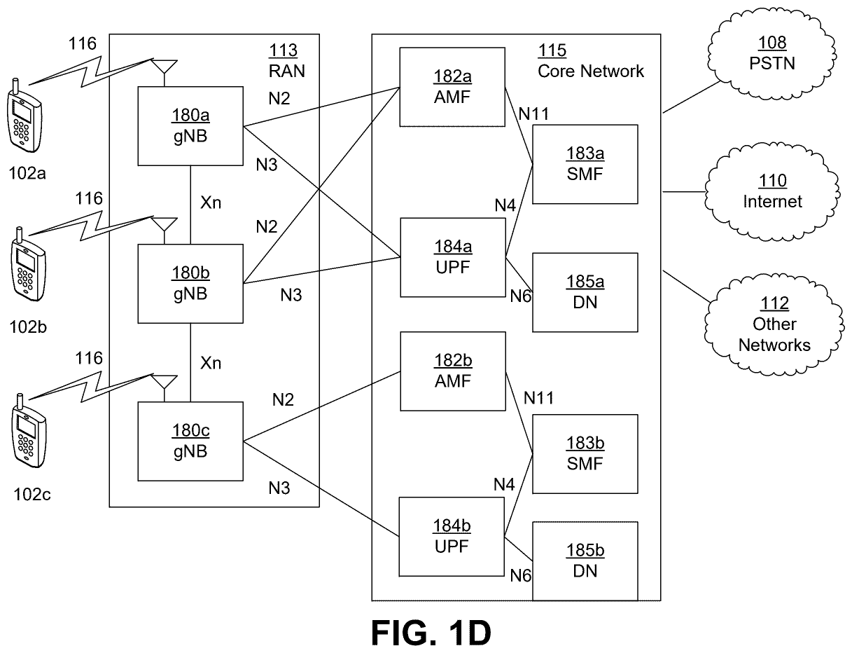

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In some examples, features described herein may include a Layer 2/Layer 3 framework for 6G user plane operation, mechanisms for power savings, and support for bursty data transmission and reception. In some examples, procedures and functions may include intermittent, bursty, and small data reception and transmission, power saving procedures, scheduling operations, utilization of low power uplink wake-up signals (UL LP-WUS) and downlink wake-up signals (DL WUS), and switching between low power radio operation and main radio operation.

In examples, the WTRU may monitor legacy paging occasions (POs) after receiving LP-WUS indicating a wake-up. For multi-beam operation of LP-WUS, the WTRU may assume that the same LP-WUS information payload is repeated in all transmitted beams corresponding to LP-WUS. In terms of conditions to monitor LP-WUS, the WTRU may start LP-WUS monitoring when a serving cell measurement performed by the MR is above an entry threshold and/or when all the measured results are above configured thresholds. The WTRU may monitor the legacy PO and/or may monitor a paging early indication (PEI), and may stop LP-WUS monitoring when a serving cell measurement performed by the low power radio (LR) is below an exit threshold. The WTRU may also be configured with LP-WUS subgrouping, where one LP-WUS codepoint may indicate one and/or all configured subgroup(s) to wake up.

In connected mode, in one configuration (e.g., option 1-1), the WTRU may monitor LP-WUS according to a LP-WUS monitoring configuration before a discontinuous reception (DRX) onDurationTimer, to trigger the starting of the onDurationTimer. In another configuration (option 1-2), the WTRU may monitor LP-WUS outside a connected-mode DRX (C-DRX) active time according to the LP-WUS monitoring configuration to trigger physical downlink control channel (PDCCH) monitoring. LP-WUS occasions may not be aligned with DRX on-durations, and the WTRU may start a new timer to monitor PDCCH upon reception of the LP-WUS indicating a wake-up. Channel state information (CSI) and/or Layer 1 reference signal received power (L1-RSRP) may be reported by the WTRU upon reception of the LP-WUS according to legacy DRX principles, which may not be aligned with a scheduling time.

With respect to 6G assumptions regarding joint energy and/or power savings and scalability, general considerations may include controlling the WTRU to minimize resource usage while enabling power savings for both the WTRU and the network (NW). The network may dynamically control cell common resources and/or power consumption broadcast signals and/or channels by adapting cell-specific configurations (e.g., by group common signaling and/or WTRU-specific control signaling). The WTRU may remain synchronized to the network. The PDCCH and/or specific downlink control information (DCI) may control cell configurations (e.g., how the cell presents itself and/or system information (SI) content), and may include controls for SI configurations. This may occur in response to an uplink (UL) LP-WUS. If a response to the UL LP-WUS is missed, a fallback procedure may be triggered (e.g., to a different configuration level). WTRU-specific power consumption modules may be dynamically added (e.g., by switching to a different power consumption configuration) when the WTRU may need to scale its bandwidth, services, quality of experience (QoE) levels, data rates, and/or utilized hardware components (e.g., in Connected mode).

Unified network-WTRU power saving may consider all network and WTRU power saving techniques jointly. A common energy savings mechanism may be implemented for all use cases. C-DRX may drive other processing components, energy consumption modules, resource usage, resource monitoring, measurements, and/or reporting. LP-WUS configuration and/or property may be used to indicate one or more access types, scheduling, and/or measurements. For example, LP-WUS may be subject to C-DRX, and when unifying, it may be necessary to determine which mechanism drives the other.

Baseline system assumptions for LP-WUS may include that downlink LP-WUS may be used to indicate information beyond wake-up (e.g., bandwidth and/or frequency domain aspects, carriers, and/or scheduling). One or more properties of a LP-WUS signal and/or a transmission/reception resource may be used to indicate information in terms of partitioning. Downlink LP-WUS may be used to indicate on-demand resources, network energy saving (NES) state changes, and/or cell discoverability. Scheduling by LP-WUS may support burst-type scheduling. For example, LP-WUS may indicate PDCCH and/or scale control resources.

Uplink LP-WUS may be used in a unified power saving framework to save energy and/or power for both the WTRU and the network and may be used to request an adaptation to the WTRU and/or the network power saving state and/or to request a resource and/or a transmission. UL LP-WUS may be used for scheduling, wake-up, and/or requesting on-demand resources.

Regarding how LP-WUS may function with multi-radio access technology (multi-RAT) spectrum sharing (MRSS), LP-WUS may indicate a 5G and/or 6G radio access configuration. One approach may include using LP-WUS partitioning that only 6G WTRUs may decode, which may wake up a 6G radio (e.g., through resource partitioning). In UL LP-WUS considerations, it may be determined whether separate LP-WUS resources are needed for 6G access versus 5G access.

Baseline assumptions for C-DRX may include that C-DRX comprises an algorithm for adaptation of WTRU processing and power consumption in one or more domains (e.g., time domain where the WTRU selectively monitors PDCCH, frequency domain where the WTRU selectively monitors portions of the bandwidth, hardware domain where the WTRU selectively uses parts of its capable hardware components and/or antenna chains, ports, and/or elements). Adaptation may occur in more than one domain, such as frequency, bandwidth, time, measurement, multiple-input multiple-output (MIMO), and/or CSI reporting domains. C-DRX may optionally be replaced by LP-WUS, may be omitted, and/or may be jointly present but controlled by LP-WUS. Switching may occur between a low power radio (LR), main radio (MR), and/or C-DRX. LP-WUS and/or DRX may drive PDCCH monitoring, and vice versa.

The WTRU may be scheduled in power saving mode without relying on C-DRX timers and/or C-DRX. Regarding C-DRX scaling, various functions may be scaled, including cycle length, data activity, PDCCH decoding level, and/or how much PDCCH resource is needed (e.g., aggregation level, control resource set (CORESET) size, blind decoding criteria, and/or decoding conditions). Scalable functions as a function of DRX state may include PDCCH monitoring, CSI measurement and/or reporting (e.g., based on data activity), bandwidth-related measurements, bandwidth parts (BWP) or used bandwidth/carriers, MIMO (including beam management), and PDSCH and/or physical uplink control channel (PUCCH) resources to use and/or activate. Modularity of user plane (UP) may be controlled by DRX adaptation. An algorithm may drive measurements in general, for example, to expand the bandwidth when a data burst is needed. Measurements related to signaling and how to report such measurements may be adapted depending on scheduling conditions.

RRC INACTIVE state alternatives may support light connectivity and/or schedulability within CONNECTED mode. In one use case, intermittent or bursty data may be supported (e.g., small data, background application refresh, web browsing, and/or bursty traffic patterns), wherein a WTRU may be inactive for a substantial percentage of the time (e.g., 90%). Each data exchange may identify the user plane function (UPF) and the WTRU without requiring a context fetch. However, security may need to be bootstrapped upon mobility. Upon mobility, L1 configurations for link adaptation, resource configurations, and/or other parameters may be lost. The xNB may determine how to route data under such conditions. Area-specific configuration across multiple cells (e.g., common radio network temporary identifier (RNTI) and/or small data transmission (SDT) resources) may be used to avoid discarding configurations maintained in a full connectivity state. RRC-less data exchange may be supported without a common control channel (CCCH) message being multiplexed. In current use cases of RRC INACTIVE, reduction of context transfers may be realized by the RRC INACTIVE state, representing a tradeoff between reachability and network signaling.

Bursty data transmission and reception may be facilitated using SDT, which may be a method allowing data and/or signaling transmission while the WTRU remains in an RRC_INACTIVE state, without transitioning to the RRC_CONNECTED state. SDT may be enabled on a radio bearer basis and may be initiated either by the WTRU in the case of mobile-originated SDT (MO-SDT) or by the network in the case of mobile-terminated SDT (MT-SDT). MO-SDT may be initiated by the WTRU only if less than or equal to a configured amount of uplink data awaits transmission across all radio bearers for which SDT is enabled, downlink RSRP is above a configured threshold, and a valid SDT resource is available. MT-SDT may be initiated by the network with an indication to the WTRU in a paging message when DL data awaits transmission for radio bearers configured for SDT. Based on the indication, the WTRU may initiate MT-SDT only if the DL RSRP is above a configured threshold. When MT-SDT is initiated by the WTRU, a resume cause indicating MT-SDT may be included in an RRCResumeRequest message.

The SDT method may be initiated with either a transmission over random access channel (RACH) or over configured grant (CG) resources. The CG resources for SDT may be valid only within the primary cell (PCell) of the WTRU when an RRCRelease with a suspend indication is received. Upon successful completion of the SDT method via an RRCRelease message including a resumeIndication, the WTRU may trigger initiation of an RRC Resume method. Upon unsuccessful completion of the SDT method, the WTRU may transition to RRC_IDLE. An initial physical uplink shared channel (PUSCH) transmission during the SDT method may include at least a CCCH message. When using CG resources, the network may schedule subsequent UL transmissions using dynamic grants, and/or such transmissions may occur during subsequent CG resource occasions. DL transmissions may be scheduled using dynamic assignments. The WTRU may initiate subsequent UL transmission only after reception of a confirmation (e.g., dynamic UL grant and/or DL assignment) for the initial PUSCH transmission from the network. The SDT method over CG resources may only be initiated when valid UL timing alignment is present. A context retrieval (e.g., using the WTRU's I-RNTI) may be required if a receiving xNB does not have the WTRU's context. The receiving xNB may identify the last serving xNB using the I-RNTI and may retrieve the WTRU context. The last serving xNB may determine whether to relocate the WTRU context and may respond with a RETRIEVE WTRU CONTEXT RESPONSE message.

To facilitate reducing xNB DL transmission and/or UL reception active time in a connected state, the WTRU may be configured with a periodic cell DTX and/or DRX pattern (i.e., active and non-active periods). The pattern configuration for cell DTX and/or DRX may be common for WTRUs configured with this feature in the cell. The network may ensure that at least partial overlap exists between the WTRU's connected mode DRX on-duration and the cell DTX and/or DRX active duration. When cell DTX is configured and activated for a given cell, the WTRU may not monitor PDCCH in selected cases and/or may not monitor semi-persistent scheduling (SPS) occasions during the cell DTX non-active duration. When cell DRX is configured and activated for a given cell, the WTRU may not transmit on CG resources and/or may not transmit a scheduling request (SR) during the cell DRX non-active duration. Cell DTX and/or DRX may be activated and/or deactivated by RRC signaling and/or Layer 1 group common signaling. Cell DTX and/or DRX may be characterized by: (a) an active duration, representing the duration that the WTRU waits to receive PDCCHs and/or SPS occasions and to transmit SR or CG, noting that in this duration, the xNB transmission/reception of PDCCH, SPS, SR, CG, periodic and semi-persistent CSI report may not be impacted for the purpose of network energy saving; and (b) a cycle that specifies the periodic repetition of the active duration followed by a period of non-active duration.

A problem may arise in how to support bursty traffic exchange of intermittent data of various sizes in a light connectivity state without relying on costly signaling overhead (e.g., incurred by Random Access (RA) and/or Radio Resource Control (RRC) message exchanges) or continual monitoring of scheduling resources, while allowing the wireless transmit/receive unit (WTRU) and the network to continue to save power while in a connected state. Assuming a low power signal (e.g., uplink (UL) low power wake-up signal (LP-WUS)) is part of a cellular system design, a challenge may exist in how the WTRU may derive UL timing alignment based on transmission of a UL LP-WUS.

New applications (e.g., mobile artificial intelligence (AI), extended reality (XR), and/or background application (App) data) may create infrequent and/or sporadic data exchange while the WTRU is not in a full connectivity state, where data may be bursty and may have unpredictable payload sizes. A challenge may exist in how to enable intermittent exchange of data while allowing the WTRU to save power and remain in RRC connected mode. A sixth generation (6G) system may not support an RRC Inactive state. The main motivation of the Inactive state may be to reduce RRC signaling caused by mobility and to perform cell reselection instead of mobility in Inactive, while allowing the WTRU to save power when there is no active exchange of data. Small data traffic may be observed as a majority of network traffic and may involve varying data sizes. While Small Data Transmission (SDT) in new radio (NR) may rely on an RRC resume request and a common control channel (CCCH) message to be included in the SDT payload, the SDT procedure may incur additional overhead (e.g., a couple of bytes) with each exchange. Such CCCH messages may not be needed if data is transmitted without involving RRC state transitions and still allows the WTRU to sleep. The CCCH message may need to reach a central unit (CU) and determine whether the WTRU's context (e.g., a set of essential configurations for data exchange in Inactive state) is available at the xNB distributed unit (DU) at which the CCCH message was received. If the context is not available, the CU may send the correct configuration to the DU, possibly after communicating with the WTRU's last serving xNB, and only after that may the SDT data be exchanged. This procedure may cause considerable intra-network signaling overhead and delay.

Preconfigured UL data resources (e.g., configured and/or semi-persistent grants) may be effective when the WTRU has UL timing advance (TA) maintained or a TA is not needed, which may place a burden on the network to keep the TA up to date. Once TA expires (e.g., when a TA maintenance timer expires), the WTRU may discard a number of configurations (e.g., UL resources including physical uplink control channel (PUCCH) and configured grant (CG) resources), and the procedure may need to proceed through RA, which may incur delay and create unnecessary load on the cell's RA capacity. RA initiated just for the exchange of an intermittent data burst may therefore cause additional signaling overhead and message exchanges that may be deemed unnecessary.

In a power saving state, a problem may arise in how the WTRU may request an UL resource for transmission of a data burst and/or a buffer status report (BSR) if resources (e.g., orthogonal frequency-division multiplexing (OFDM)-based resources that require the main radio (MR) at the WTRU and/or network to be turned on) are not available. The WTRU may leverage UL low power signal (e.g., UL LP-WUS) to request UL resources, report buffer status, and receive scheduling for a burst of data.

When a timeAlignmentTimer expires, the WTRU may flush all hybrid automatic repeat request (HARQ) buffers, release PUCCH and sounding reference signal (SRS) resources, clear configured downlink assignments and configured UL grants, and clear any physical uplink shared channel (PUSCH) resource for semi-persistent channel state information (CSI) reporting. These consequences may be severe and may force the network to keep the WTRU's timing alignment timer running indefinitely in practice (e.g., by continuously sending timing alignment medium access control control elements (MAC CEs)), even when there is no active data exchange ongoing in connected mode. The network may alternatively send the WTRU to Inactive state, but the WTRU may lose configurations that are not part of the Inactive state context configuration. A challenge may arise in supporting a system design where the validity and maintenance of UL control and data resources are not tied to expiry of a timing advance value.

Assuming a low power signal (e.g., UL LP-WUS) is part of a cellular system design, a problem may also arise in how the WTRU may derive UL timing alignment based on transmission of a UL LP-WUS. The WTRU may determine UL timing (at least for the UL-WUS) based on downlink synchronization to common DL signals. The WTRU may determine uplink timing for a UL-WUS signal and UL timing for UL transmission on OFDM resources following the UL-WUS transmission.

While NR may have introduced downlink LP-WUS, no UL LP-WUS component may be included. However, there may be a need to incorporate UL LP-WUS into design considerations for a unified WTRU/network power saving framework. UL LP-WUS may be important for enabling network-side energy saving techniques while not impacting UL data quality of service (QoS) and/or latency.

Cell discontinuous transmission/discontinuous reception (DTX/DRX) may be largely designed independently from LP-WUS operation. During cell DRX non-active periods, the WTRU may wait until the next active period to transmit scheduling requests, BSRs, and/or newly arrived data. There may be no support for low power RA or WUS transmission during xNB sleep periods.

Referring now to the focused solution, a goal may be to support exchange of data (e.g., intermittent and/or bursty) without requiring scheduling of a DCI for each exchange, use of RA, or switching to other RRC states, while allowing the WTRU and the network to remain in a power saving state. A WTRU may monitor downlink physical downlink shared channel (PDSCH) resources upon reception of a wake-up signal (WUS) for reception of a data burst, and/or may transmit on PUSCH resources and/or monitor PDCCH upon transmission of UL LP-WUS. TA may be estimated by the WTRU based on received DL signals, may be estimated by the xNB based on the transmitted UL-WUS signal, and/or may be explicitly received following a UL LP-WUS signal.

A scheduling request may be transmitted as a function of LP-WUS transmission and resource selection (e.g., sequence and/or resource), where the resource selection may provide dimensioning of an appropriate grant. A WTRU may be configured with one or more power saving configurations, during which it may request a grant for UL data transmission by transmission of a UL low power signal (e.g., UL LP-WUS). The WTRU may determine that the cell is operating in a given power saving configuration based on reception of explicit signaling (e.g., system information (SI), physical broadcast channel (PBCH), downlink control information (DCI), MAC CE, and/or DL WUS indicating activation and/or application of the power saving configuration), or based on implicit indications from type of access or from received reference signals (RS) and/or synchronization signals (SSS).

The WTRU may be configured with a plurality of properties of a low power signal that may be used to indicate to the network a request for scheduling. A property may include a time occasion of transmission, a frequency allocation of the transmission (e.g., physical resource block (PRB), bandwidth part (BWP), and/or carrier), a subgroup associated with the low power signal, a sequency type and/or length associated to encode the signal, and/or a sequency and/or RNTI used to scramble the signal and/or identify the WTRU. The WTRU may be configured with a plurality of partitions for UL low power signal, where each partition may be defined by one or more low power signal properties. Each partition may be used to request a grant of a specific size (e.g., a minimum size and/or a range), indicate coverage or a channel measurement level and/or range (e.g., a reference signal received power (RSRP) range or RSRP being less than a configured threshold), indicate a measured CSI or channel quality indicator (CQI) level and/or range, and/or provide an indication for data arrival for one or more data flows.

Uplink data may arrive at the WTRU buffer, which may trigger a BSR and/or scheduling request. While operating in the power saving configuration, the WTRU may transmit a request for scheduling using a low power signal (e.g., from the low power radio). The WTRU may select the transmission property and partition for the UL LP-WUS as a function of the measured channel conditions and/or CQI, the size of the arrived uplink data for transmission, and/or the data flow from which the data arrived. The WTRU may receive a grant for transmission, a timing advance, and/or an acknowledgment (ACK) to transmit uplink data. The WTRU may transmit uplink data using the received grant and/or a configured grant.

A WTRU may be configured with a plurality of power saving configurations for the exchange of bursty data, where each configuration may represent an operational mode for scheduling and power saving. In the context of two power saving configurations (though more than two may be supported), one power saving configuration may be used for full connectivity and main radio (MR) operation (e.g., Connected/MR operation). In this configuration, the WTRU may have full schedulability and may monitor the physical downlink control channel (PDCCH) based on a first configuration (e.g., normal PDCCH monitoring).

In a second power saving configuration, the WTRU may operate based on the exchange of low power signals to activate further MR transmissions (e.g., Inactive/LP mode operation). In this configuration, the WTRU may save power by switching off the MR. The WTRU may monitor downlink low power wake-up signal (DL LP-WUS) instead of PDCCH for scheduling, and may use uplink low power wake-up signal (UL LP-WUS) to initiate transmission of data and/or control information. The WTRU may not need to monitor PDCCH in accordance with connected-mode discontinuous reception (C-DRX), or may monitor a subset of PDCCH resources based on a second configuration. Some uplink and/or downlink resource configurations (e.g., physical uplink control channel (PUCCH), sounding reference signal (SRS), configured grant/semi-persistent scheduling (CG/SPS), and/or physical downlink shared channel (PDSCH)) may be suspended even when the timing advance (TA) is outdated, while keeping resource configurations valid. Such configuration may remain valid within an area (e.g., a radio access network (RAN) paging area, possibly identified by a radio network temporary identifier (RNTI)). Some uplink and/or downlink data flows may also be suspended.

A bursty data exchange may be performed without RRC signaling while the WTRU operates in the Inactive/LP mode operation power saving configuration. Uplink data may be triggered by UL LP-WUS. Upon an uplink data arrival condition, the WTRU may transmit a low power UL-WUS (instead of a scheduling request (SR) or RA) to request transmission on configured orthogonal frequency-division multiplexing (OFDM) resources or to request a grant. If the WTRU is not time-aligned, it may transmit a UL LP-WUS sequence (based on downlink synchronization), and in a subsequent OFDM transmission the WTRU may refine UL timing. A downlink indication may provide TA correction to apply for the MR transmission (e.g., OFDM-based), or may be estimated by the WTRU based on received downlink signals (e.g., synchronization signal block (SSB) or a low power signal).

The WTRU may transmit on a given UL LP-WUS configuration and/or subgroup as a function of the TA validity, the estimated timing from the received downlink synchronization signal, whether the WTRU needs an uplink grant or intends to transmit on a physical uplink shared channel (PUSCH) resource, the WTRU's measured coverage and/or channel condition, and/or the size of the buffered data and/or data burst for transmission. The WTRU may use a downlink pathloss estimate to determine the transmission power of the LP-WUS on uplink, or may transmit UL-WUS according to a configured target transmission power.

The WTRU may transmit data, without RRC messages, on a configured PUSCH resource following UL LP-WUS transmission or reception of a reply to the UL LP-WUS (e.g., acknowledgment (ACK), DCI, TA command, and/or DL LP-WUS). The WTRU may temporarily activate the MR to exchange data and then may return to LP operation configuration after the data exchange is complete. The WTRU may switch to MR operation if it indicates it has subsequent data to transmit, or if no uplink resource is available (e.g., a BSR may be multiplexed, a low power signal-based SR may be transmitted, and/or a second UL LP-WUS configuration or subgroup may be used to indicate this), or if an instruction is received. The data may be exchanged on dynamic grants. The PDCCH monitoring period may be governed by a timer.

Data transmission may be conditioned on being within the list of cells defined in the configured area RNTI, or on having a valid TA. The WTRU may switch back to LP operation mode upon expiry of a timer, successful transmission of the data that triggered the LP-WUS, and/or detection that the buffer is empty and no subsequent BSR is reported.

If a DL LP-WUS is received on a first configuration or subgroup, the WTRU may monitor for downlink data reception on configured PDSCH resources. The WTRU may temporarily activate MR to exchange data, and then return to LP operation after the data exchange is complete, without PDCCH monitoring. The WTRU may monitor PDCCH (i.e., switch to MR operation) if it receives a DL LP-WUS on a second configuration or subgroup or an indication to receive subsequent DL data (e.g., on PDSCH). The PDCCH monitoring period may be governed by a timer.

Additional conditions may be used to trigger switching between power saving configurations (e.g., between a low activity configuration and a full connectivity configuration). Such conditions may include reception of network control signaling (e.g., DCI, LP-WUS, and/or a property of the received DCI or LP-WUS), data volume or latency (e.g., a BSR or downlink scheduling request (DSR) where the volume exceeds a threshold or the latency or remaining time is below a threshold), data arrival from a given data flow (e.g., arrival from a suspended data flow), and/or TA validity conditions (e.g., RSRP change exceeding a threshold or expiry of the TA timer). Expiry of a timer may also be used. For example, upon expiry of a scheduling or C-DRX inactivity timer, the WTRU may switch to LP mode operation (e.g., no C-DRX), and the WTRU may switch to Inactive/LP mode operation upon expiry of the TA timer. If channel measurements on LP-WUS-based signals (e.g., LP-SS) are below a threshold, the WTRU may enter a mode where scheduling is governed by MR operation.

The WTRU may provide uplink indications to notify the network of mode switching in cases where the network may not be aware of the mode transition (e.g., when the mode is switched without a LP-WUS exchange). The indication may be a RA procedure and/or a scheduling request instead of UL-WUS if the coverage in LP mode is not above a threshold or TA has expired. The indication may also be provided using MAC CE, RRC signaling, and/or PUCCH in MR mode.

LP-WUS may be used to indicate the start of a timer to monitor PDCCH for one or more data bursts. The WTRU may perform scheduling of data, transmission of data on configured resources, and/or a switch of scheduling operation mode based on the LP-WUS. Upon expiry of the timer, the WTRU may stop monitoring PDCCH until the next LP-WUS is detected. The WTRU may restart the timer or control the timer value as a function of received and/or transmitted data and/or whether subsequent data is to be received or transmitted.

This approach may enable scaling of WTRU schedulability and exchange of data volumes quickly. RRC overhead-free data exchange may be enabled while still achieving power savings. WTRU and network power and/or energy savings may be realized. The method may avoid signaling overhead associated with RRC state transitions and may eliminate paging and RA overhead otherwise associated with intermittent data exchange.

The following terminology may be used and may be assumed throughout this disclosure. The term channel conditions may refer to any conditions relating to the state of the radio and/or channel, which may be determined by the wireless transmit/receive unit (WTRU) from a WTRU measurement (e.g., Layer 1 signal-to-interference-plus-noise ratio (L1/SINR), reference signal received power (RSRP), channel quality indicator/modulation and coding scheme (CQI/MCS), channel occupancy, received signal strength indicator (RSSI), power headroom, and/or exposure headroom), Layer 3 and/or mobility-based measurements (e.g., RSRP, reference signal received quality (RSRQ), s-measure), a radio link monitoring (RLM) state, and/or channel availability in unlicensed spectrum (e.g., whether the channel is occupied based on determination of a listen-before-talk (LBT) procedure and/or whether the channel may have experienced a consistent LBT failure). Channel conditions may be measured using the main radio and associated signals, and/or may be measured using the low power radio and associated low power signals.

The term uplink control information (UCI) may include channel state information (CSI), hybrid automatic repeat request (HARQ) feedback for one or more HARQ processes, scheduling request (SR), link recovery request (LRR), configured grant UCI (CG-UCI), and/or other control information bits that may be transmitted on the physical uplink control channel (PUCCH) and/or physical uplink shared channel (PUSCH).

The term WTRU power saving state may refer to a state related to the WTRU's power consumption, including connected-mode discontinuous reception (C-DRX) (e.g., active or not active, on-duration running or not), a network (NW) energy saving state, a network congestion state, a memory consumption state, a central processing unit (CPU) consumption state, a WTRU overheating state, a throughput capacity, and/or an associated capability or ability to support one or more features.

The term low power wake-up signal (LP-WUS) property may refer to a property of an uplink or downlink low power signal (e.g., LP-WUS), including a bandwidth part (BWP) used for transmission and/or reception, the monitoring occasion on which LP-WUS is received, the transmission occasion on which the UL LP-WUS is transmitted by the WTRU, the frequency domain allocation of the LP-WUS signal, the sequence used to transmit or receive the LP-WUS signal, the modulation type used to transmit the LP-WUS (e.g., orthogonal frequency-division multiplexing (OFDM) based and/or on-off keying (OOK) based), the energy and/or power at which the LP-WUS signal is received, and/or the power at which the UL LP-WUS signal is transmitted.

The term bursty data may include bursty, intermittent, and/or small data, data from configured data flows in the power saving configuration, and/or any data.

The term xNB may refer to a new generation base station or node-B.

A property of scheduling information (e.g., an uplink grant or downlink assignment) may consist of at least one of the following: a frequency allocation; a time-related aspect such as a time instance and/or a time duration; a priority; a modulation and coding scheme (MCS); a transport block size; a number of spatial layers; a number of transport blocks to be carried; a transmission configuration indicator (TCI) state or a spatial relationship index (SRI); a number of repetitions; or a designation of whether the grant is a configured grant of type 1 (i.e., the WTRU immediately uses the configured UL resources after receiving the configuration information), type 2 (i.e., the WTRU waits until an explicit medium access control control element (MAC CE) indication before using the configured UL resources), or a dynamic grant.

An indication by DCI, or more generally an indication, may consist of at least one of the following: an explicit indication by a DCI field or by a radio network temporary identifier (RNTI) used to mask a cyclic redundancy check (CRC) of the physical downlink control channel (PDCCH); an implicit indication based on a property such as a DCI format, DCI size, control resource set (coreset) or search space, aggregation level, identity of the first control channel element (CCE) used for the DCI, where the mapping between the property and the value may be signaled by RRC or MAC; or an explicit indication by a downlink MAC CE.

In this disclosure, the terms a, an, and similar terms may be interpreted as one or more and at least one. Similarly, any term which ends with the suffix(s) may be interpreted as one or more and at least one. The term may may be interpreted as may, for example. A forward slash symbol (/) may represent and/or, where for example, A/B may imply A and/or B.

A logical channel (LCH) and data flows may be used interchangeably. A service data unit (SDU) may refer to a data unit or a packet, which may include a full SDU or a segment of a SDU. While the description herein may define an SDU as the unit of evaluation, the same conditions may apply to evaluation of a remaining segment of an SDU.

While NR may not support a low power signal transmitted in the uplink direction, it may be anticipated that future cellular systems may benefit from a bidirectional uplink transmitter and receiver architecture, where the UL LP-WUS may be used in a unified power saving framework to save energy and/or power for both the WTRU and the network, and may be used to request an adaptation to the WTRU and/or network power saving state, and/or to request a resource or a transmission.

A UL WUS signal design may include transmission of OOK, frequency-shift keying (FSK), OFDM, and/or amplitude shift keying (ASK) waveforms. The signal may be a preamble, a sequence, and/or a physical random access channel (PRACH) preamble. In one low power hardware realization, backscattering technology and receiver architectures based on envelope detection may be used. In a different realization, very low power consumption heterodyne and/or homodyne architectures may be used, while satisfying a low complexity design target. The device may be rated based on a quality required in circuitry such as energy harvesting, backscattering, and/or power amplifiers (PAs).

An LP-WUS transmitter device may be characterized based on its energy storage capacity and capability to generate radio frequency (RF) signals for transmission. The device may have limited energy storage or limited transmission power for the LP-WUS transmitter (PcMax) as compared to the main radio. For example, one device and/or transmission state may not include energy storage and may lack independent signal generation or amplification (i.e., backscattering transmission). Another device and/or transmission state may support energy storage but no independent signal generation (i.e., backscattering transmission). Stored energy may be used for amplification of reflected signals. Another device and/or transmission state may include energy storage and independent signal generation (i.e., active RF components for transmission). In one example, one device and/or transmission state may be assumed for the low power radio and another for the main radio. A set of waveforms, modulation and coding schemes, and/or transmission powers may be assumed in a given device and/or transmission state, which may be predefined and/or configured.

In some examples, the WTRU may be configured with a plurality of power saving configurations for the exchange of data (e.g., bursty and/or intermittent data in a power saving state). Each power saving configuration may represent a WTRU operation mode for scheduling and power saving and/or may be associated with a set of WTRU behaviors and assumptions for data scheduling, control channel monitoring, and/or requesting resources for data transmission. Each power saving configuration and/or operation mode may be associated with uplink data, downlink data, or both uplink and downlink data scheduling and/or transmission and reception. The WTRU may operate with the assumptions associated with a power saving configuration when the configuration is used and/or activated. In such cases, the WTRU may operate in an operation mode according to the power saving configuration. Activation of a power saving configuration may be signaled to the WTRU or may be determined by the WTRU itself. A number of power saving operation modes may be configured and operated in RRC connected state and/or RRC inactive state.

In a first power saving configuration and/or operation mode, referred to herein as “full connectivity/main radio (MR) operation,” the WTRU may operate with the MR on (e.g., assuming a separate radio chain is employed for LP-WUS circuitry than for the MR), with the assumption of full scheduling capabilities including blind decoding for control channel monitoring. The WTRU may monitor the PDCCH based on a first configuration (e.g., normal PDCCH monitoring).

In a second power saving configuration and/or operation mode, referred to herein as “low activity/low power (LP) radio operation,” the WTRU may operate using the low power radio (e.g., a radio used to transmit and/or receive low power signals such as UL and/or DL LP-WUS, assuming a separate radio chain is employed for LP-WUS circuitry than the MR). The WTRU may monitor the PDCCH according to a second configuration (e.g., a subset of PDCCH resources such as search spaces, blind decoding occasions, and/or coreset elements). The WTRU may save power by switching off the MR (e.g. not monitoring a subset of resources associated with the main radio) while operating in such power saving operation mode. The WTRU may monitor DL LP-WUS (possibly instead of PDCCH) for scheduling. The WTRU may transmit a UL low power signal (e.g., UL LP-WUS) to initiate transmissions of data or control information. The WTRU may operate according to a particular C-DRX assumption (e.g., C-DRX deactivated, C-DRX activated with a given cycle, cell DTX activated, cell DRX activated, and/or a defined periodicity associated with monitoring and/or transmitting DL/UL signals and channels).

In a given power saving configuration and/or operation mode (e.g., during the low activity/LP operation mode), a number of resource configurations may be assumed, persisted at the WTRU, and used while operating in such mode. These resource configurations may include one or more of the following:

The WTRU may be configured with uplink data transmission resources, including PUSCH resources, configured grants, and/or other resources on which uplink data may be transmitted (e.g., PRACH and PUSCH). The configuration may indicate whether the resource may be used with or without a valid timing advance (TA) value or when the TA is less than a configured threshold.

The WTRU may be configured with downlink data transmission resources, including PDSCH resources, downlink configured grants and/or semi-persistent scheduling (SPS) resources, and/or resources on which downlink data may be transmitted (e.g., PRACH and PDSCH).

The WTRU may be configured with uplink low power signal transmission occasions and/or associated assumptions, and/or downlink low power signal monitoring occasions and/or assumptions.

The WTRU may be configured with downlink control channel resources and/or assumptions, including PDCCH resources, search spaces, blind decoding occasions, and/or control resource sets.

The WTRU may be configured with uplink control channel resources and/or assumptions, including PUCCH resources, SRS transmission resources, and/or UCI types that may be transmitted.

The WTRU may be configured with a list of cells for which the configuration is applicable, including a list of physical cell identifiers (PCIs), a list of radio units, and/or cells connected to the same central unit xNB processor. The cells may belong to the same TA group.

The WTRU may be configured with a list of data flows (e.g., logical channels (LCHs)) from which data may be transmitted and/or received, such as data flows that may be kept or suspended.

The WTRU may be configured with a list of radio bearers and/or quality-of-service (QoS) flows that may be assumed to be either suspended or kept.

The WTRU may be configured with an RNTI associated with the power saving configuration and/or operation mode, and/or with the security and/or integrity protection configuration to apply and assume.

The WTRU may be configured to assume and measure one or more synchronization signals (e.g., synchronization signal block (SSB), low power synchronization signal, and/or discovery signal).

The WTRU may be configured with one or more beams associated with sources from which data, broadcast signals, and/or channels may be assumed.

The WTRU may be configured with a BWP and/or one or more carriers to assume for activation.

The WTRU may be configured with one or more CSI reference signals (CSI-RS) and/or SSB transmission assumptions and/or periodicities.

The WTRU may be configured with a set of Layer 1 and/or Layer 3 measurement configurations, including measurement occasions, measurement gaps, CSI reporting configurations, and/or SSB measurement configurations (e.g., synchronization signal measurement timing configuration (SMTC)).

The WTRU may be configured with measurement channel conditions (e.g., a range or a threshold) associated with operating in the given power saving configuration.

The WTRU may be configured with a set of random-access resources.

In one realization, the WTRU may assume multiple active power saving configurations and/or operation modes, possibly one per protocol stack and/or radio processing component, and/or possibly if multiple radio chains are active.

Upon mobility to a cell that is not included in the list of cells for which the configuration is applicable and/or when the RNTI on which the associated security configuration is applicable is no longer valid, the WTRU may notify the network and/or acquire a new configuration for the power saving mode. The notification to the network may be provided via a radio resource control (RRC) procedure or a MAC procedure. The WTRU may turn on the main radio to initiate the procedure and/or may switch to a different power saving configuration (e.g., one associated with full connectivity).

While operating using a power saving configuration and/or operation mode (e.g., the second configuration, LP mode, or low activity mode), the WTRU may transmit data. The data may include bursty data, intermittent data, small data, data from configured data flows in the power saving configuration, and/or any other data. Transmission of data during such an operation mode may be initiated by transmission of an uplink low power signal (e.g., LP-WUS), reception of a downlink low power signal, arrival of uplink data at the WTRU buffer (e.g., possibly from a subset of data flows configured in the power saving configuration), and/or triggering of a buffer status report (BSR).

In one implementation, while operating using a power saving configuration (e.g., the second configuration), the WTRU may determine whether to initiate transmission of an uplink low power signal or to initiate a transition to a non-power saving configuration (e.g., the first configuration) based at least in part on the result of a timing advance (TA) validity verification procedure. The TA validity verification procedure may be initiated in response to uplink data being available for transmission in the buffer and the amount of uplink data being equal to or greater than a configured threshold.

In one method, the WTRU may trigger a request for scheduling, an indication of uplink data arrival, a request to transmit bursty data, and/or an indication to initiate transmission of data by transmitting an uplink low power signal (e.g., UL LP-WUS). Such transmission may be performed while the WTRU operates in a power saving configuration corresponding to a low activity and/or LP mode operation. Transmission of an uplink LP-WUS may be performed in lieu of a transmission of a scheduling request (SR) and/or PRACH transmission. For example, such SR or PRACH transmissions may not be available in the current power saving configuration or operating mode and/or may require the WTRU to activate the main radio, which the WTRU may avoid while operating in the power saving configuration.

In some examples, a two-step method may be implemented. An uplink low power wake-up signal (UL LP-WUS) may be used by a wireless transmit/receive unit (WTRU) to activate and/or indicate an uplink control or data resource. In a two-step procedure, the WTRU may transmit data and/or control after transmission of an uplink low power signal. The uplink low power signal may act as an activation signal for a subsequent uplink data and/or control transmission, which may require turning on the main radio. The WTRU may transmit the subsequent transmission either after transmission of the UL low power signal and turning on the main radio, or after reception of a reply and/or indication from the network acknowledging the first transmission (e.g., an ACK, a downlink LP-WUS signal, a DCI/PDCCH signal, a timing advance command). A suspended data and/or control resource (e.g., PUSCH, PUCCH, CG, RA, and/or SDT resource) may be assumed to be activated following the transmission of the first low power signal or receiving a reply to it.

The WTRU may transmit data (e.g., bursty data), possibly without RRC messages multiplexed on the same transmission, on a configured PUSCH resource (e.g., a configured grant) following UL LP-WUS transmission or reception of a reply to it (e.g., ACK, DCI, TA command, and/or DL LP-WUS). The WTRU may activate the main radio (e.g., temporarily) to exchange data and then may go back to LP operation configuration after the data exchange is completed.

The WTRU may keep the main radio on until the transmission of data is performed, until an ACK is received to the transmitted data, until all buffer status reports (BSRs) are cancelled, until there is no further uplink data to transmit, until there is no indication of further uplink data to transmit (e.g., a request for scheduling and/or BSR) multiplexed in an uplink transmission, if the WTRU does not have further grant (e.g., a PUSCH resource) for further data transmission, if a timer expires without any additional UL data available for transmission (where the timer restarts at each UL transmission), if the buffered data that triggered the first low power signal is successfully transmitted, and/or if no subsequent BSR is reported for a period of time. The WTRU may revert to the LP mode power saving configuration and/or operation mode after one or more of these conditions are met.

The WTRU may start a timer (e.g., MR timer, C-DRX inactivity timer, and/or any C-DRX timer) upon transmitting the UL low power signal, upon reception of a reply to the UL LP-WUS signal, upon transmitting the uplink data, and/or upon transmitting a BSR. The WTRU may monitor PDCCH while the timer is running or may assume operation according to a different power saving configuration (e.g., a first power saving configuration and/or full connectivity). The WTRU may stop the timer once the buffered data that triggered the first low power signal is successfully transmitted. The WTRU may stop the timer if no subsequent BSR is reported. The WTRU may switch back to LP mode power saving configuration and/or operation mode upon expiry of the MR timer and/or may activate C-DRX or another power saving configuration. Upon expiry of the timer, the WTRU may stop monitoring PDCCH until the next LP-WUS is detected. The WTRU may restart the timer or control the timer value as a function of the received and/or transmitted data and/or whether there is subsequent data to receive and/or transmit. For example, if data arrives from data flow 1, the WTRU may start the timer with value 1. If data arrives from data flow 2, the WTRU may start the timer with value 2, and so on. If the WTRU receives an indication for subsequent downlink data and/or transmits and/or multiplexes an indication for subsequent uplink data transmission, the WTRU may start the timer with a different configured value. Similarly, if a retransmission is pending as indicated (e.g., a NACK), the WTRU may restart the timer using a third configured value, and so on.

The WTRU may transmit the first uplink low power signal using a specific configuration, property, and/or subgroup as a function of whether it needs an uplink grant or intends to transmit on a PUSCH resource, the type of data and/or control it intends to transmit in the second transmission, and/or the size of the buffered data or data burst for transmission (to be transmitted in the second transmission). For example, the WTRU may transmit the first low power transmission using sub configuration 1 to indicate scheduling of a grant of size x (at least x bits), sub configuration 2 to indicate scheduling of a grant of size y (of at least y bits), and so on. The first transmission may also indicate the data flow from which the WTRU intends to transmit, the type of data (e.g., control plane, user plane, data plane, sensing, and/or AI/ML), and/or the type of control data (e.g., UCI type) it intends to send. The WTRU may also measure and report CSI and/or transmit SRS following the transmission of the first low power signal transmission.

If configured, the WTRU may condition the second step transmission of uplink data and/or control (e.g., a main radio transmission) on one or more of the following conditions: the uplink transmission being performed on a serving cell within the list of cells configured for the power saving configuration and/or operation mode or the serving cell belongs to the same timing advance group as the cell that has configured the resource or the cells for which the resource is configured as valid; reception of a reply to the UL low power signal (e.g., ACK, DCI, TA command, and/or DL LP-WUS), possibly indicating a specific RNTI (e.g., one associated with the power saving configuration), a sub-configuration associated with the LP-WUS, and/or a specific configured property of the LP-WUS; the uplink resource being valid, where validity may be determined by the WTRU as a function of the serving cell and/or the received acknowledgement to the UL LP-WUS; having a valid timing advance (TA), e.g., receiving a TA following the transmission of the UL LP-WUS. The WTRU may maintain the validity of TA by a timing advance timer (TA valid while timer is running, TA invalid once timer expires, timer restarts upon receiving a TA command and/or TA correction and/or estimating a new TA value); measured channel conditions being within a range, below, or above a configured threshold (e.g., RSRP greater than a threshold). The WTRU may determine that a TA is valid if the measured channel conditions (e.g., RSRP) have not changed by more than a configured margin; based on the estimated and/or determined TA value being within a range or less than a threshold. The TA may be estimated by the WTRU from a received downlink signal (e.g., a synchronization signal or an on-demand synchronization signal); and/or based on transmitting an UL low power signal that can be used by the network to estimate the uplink timing advance (e.g., from a sequence).

The WTRU may monitor PDCCH instead of transmitting a second data transmission if it has indicated a scheduling request as part of the first transmission, if it does not have a valid grant and/or timing advance, and/or if the available grant and/or resource is more than x milliseconds and/or slots away, where x may be a configured value.

If the WTRU is not time-aligned, the WTRU may transmit an uplink low power signal (e.g., an UL LP-WUS) and/or a sequence that may be used by the network to estimate the WTRU's required uplink timing advance. The WTRU may select an uplink low power signal sequence, a property of the UL LP-WUS signal, and/or an initial timing advance (e.g., time gap) to transmit the UL low power signal based on a received downlink signal (e.g., a downlink synchronization signal, an LP-synch signal, an on-demand signal, and/or a cell discovery signal) and may synchronize to it (e.g., based on the determined DL frame time and start offset). In a second and/or subsequent transmission following the low power uplink signal (e.g., the uplink data and/or control signal, which may be an OFDM transmission), the WTRU may refine uplink timing. The WTRU may refine the subsequent transmission timing based on a downlink indication that may provide a timing advance (TA) correction to apply for the main radio transmission (e.g., OFDM-based) or may be estimated by the WTRU based on received downlink signals (e.g., SSB and/or a low power signal). The downlink indication may be signaled explicitly (e.g., in a DCI, MAC CE, and/or PDSCH), or may be determined by the WTRU implicitly from a received ACK and/or DL LP-WUS. For example, the WTRU may determine a TA value, TA range, and/or TA correction and/or delta from a property of the received DL LP-WUS (e.g., the sub-configuration used, and/or the time, frequency, and/or occasion used for the DL LP-WUS reception), or from a scheduling property of the DCI.

The WTRU may transmit the uplink low power signal (e.g., UL LP-WUS) using a specific configuration, property, and/or subgroup as a function of (a) the TA validity—i.e., whether the WTRU has a valid TA that is maintained by a timer, (b) the estimated timing from the received DL synchronization signal, (c) whether the WTRU needs an uplink grant or intends to transmit on a PUSCH resource, (d) the WTRU's measured coverage and/or channel conditions being above or below a threshold, (e) the size of the buffered data and/or the data burst for transmission, and/or (f) the latency and/or remaining time associated with the buffered data.

The WTRU may use a downlink pathloss estimate signal (e.g., from a downlink synchronization signal, an LP-synch signal, an on-demand signal, and/or a cell discovery signal) to determine the transmit power of the UL LP-WUS and/or may transmit the UL LP-WUS according to a configured target transmission power. The WTRU may transmit the UL LP-WUS using a specific configuration, property, and/or subgroup.

While operating using a power saving configuration and/or operation mode (e.g., the second configuration, LP mode, and/or low activity mode), the WTRU may receive data (e.g., bursty, intermittent, small data, data from configured data flows in the power saving configuration, and/or any data). Reception of data during such operation mode may be initiated by reception of a DL low power signal (e.g., LP-WUS), possibly from a specific subgroup, configuration, and/or property, and/or reception of a paging indication.

In one method, if a DL LP-WUS is received on a first configuration and/or subgroup, the WTRU may monitor for downlink data reception on configured PDSCH resources. The WTRU may temporarily activate the main radio to exchange data and then may return to the LP operation configuration after the data exchange is completed, without monitoring the PDCCH. The WTRU may monitor the PDCCH—i.e., switch to a first power saving configuration and/or MR operation mode—if it receives DL LP-WUS on a second configuration and/or subgroup, or an indication to receive subsequent DL data (e.g., on PDSCH).

The time spent in the first power saving configuration (e.g., MR operation mode and/or PDCCH monitoring period) may be governed by a new timer.

The WTRU may receive data (e.g., bursty data), possibly without RRC messages multiplexed on the same transmission, on a configured PDSCH resource (e.g., a configured grant) following DL LP-WUS reception or after transmitting a reply to it (e.g., ACK, UCI, PUCCH, and/or UL LP-WUS). The WTRU may activate the main radio (e.g., temporarily) to exchange data, and then may go back to LP operation configuration after the data exchange and/or reception is completed. The WTRU may keep the main radio on until the reception and/or transmission of data is performed, until an ACK is transmitted to the received data, until there is no further uplink data to transmit, until there is no indication of further uplink data to transmit (e.g., a request for scheduling and/or BSR) multiplexed in an uplink transmission, and/or until there is no indication of further downlink data to receive that is received multiplexed in a downlink transmission. The WTRU may revert to the LP mode power saving configuration and/or operation mode after one or more of these conditions are met (e.g., turn off the main radio, activate C-DRX, etc.).

The WTRU may start a timer (e.g., MR timer, C-DRX inactivity timer, and/or any C-DRX timer) upon receiving the DL low power signal, upon transmission of a reply to the DL LP-WUS signal, upon receiving the downlink data, and/or upon not receiving an indication to restart the timer, to keep the main radio on, and/or to continue monitoring the PDCCH. The WTRU may monitor PDCCH while the timer is running or may assume operation according to a different power saving configuration (e.g., a first power saving configuration and/or full connectivity). The WTRU may switch back to LP mode power saving configuration and/or operation mode upon expiry of the MR timer. Upon expiry of the timer, the WTRU may stop monitoring PDCCH until the next LP-WUS is detected. The WTRU may restart the timer or control the timer value as a function of the received and/or transmitted data and/or whether there is subsequent data to receive and/or transmit. For example, if data arrives from data flow 1, the WTRU may start the timer with value 1; if data arrives from data flow 2, the WTRU may start the timer with value 2; and so on. If the WTRU receives an indication for subsequent downlink data and/or transmits or multiplexes an indication for subsequent uplink data transmission, the WTRU may start the timer with a different configured value. Similarly, if there is a retransmission pending (e.g., a NACK is indicated), the WTRU may restart the timer using a third configured value, and so on. The WTRU may stop the timer and switch back to the LP mode power saving configuration and/or operation mode in response to reception of a downlink indication received on either the PDCCH or the PDSCH.

The WTRU may be configured and/or predefined to switch between power saving configurations, either autonomously by the WTRU or upon receiving an indication and/or instruction from the network.

In some examples, the WTRU may switch from a first power saving configuration to a second power saving configuration and/or operation, where the second power saving configuration may allow for more power savings than the first power saving configuration and/or vice-versa, if at least one of the following conditions may be met. The conditions may include reception of network control signaling (e.g., DCI, LP-WUS, property of the received DCI and/or LP-WUS), including reception of signaling to switch to “connected/MR operation” upon reception of a PDCCH order, timing advance command, and/or an LP-WUS indication. Additionally and/or alternatively, conditions may include a data volume and/or latency evaluation (e.g., based on a BSR and/or DSR), where the volume may be less than or greater than a configured threshold, and/or the latency and/or remaining time of buffered data may be larger than or smaller than a configured threshold. The WTRU may also determine switching is needed based on data arrival and/or reception from a data flow that is suspended or not associated with the active power saving configuration and/or operation mode. The switching may also occur based on timing advance validity, which may be determined invalid if a change in RSRP is more or less than a configured threshold and/or upon timing advance timer expiry.

In some examples, switching may be based on the expiry of a timer. For example, upon expiry of a scheduling timer (e.g., MR timer) or a C-DRX timer (e.g., inactivity timer and/or retransmission timer), the WTRU may switch to LP mode operation (e.g., no C-DRX). Additionally and/or alternatively, the WTRU may switch to LP mode operation upon expiry of the timing advance timer. Channel measurement-based switching may occur if channel measurements on LP-WUS-based signals (e.g., LP-SS and/or RSRP) fall below a configured threshold, in which case the WTRU may enter scheduling by MR mode operation. In another example, the number of LP-WUS transmissions performed for bursty data exchange over a defined time period may be used by the WTRU to determine whether to activate C-DRX, determine the DRX cycle length and/or period. The WTRU may also determine switching is needed based on a misdetection of a number of DCI(s) and/or LP-WUS signals.

The WTRU may notify the network by providing an uplink indication for mode switching upon switching to another power saving configuration and/or operation mode. In one example, the WTRU may provide the indication only if the switch is made autonomously by the WTRU without network signaling or involvement. The indication may be included in a MAC CE, UCI, and/or PUCCH transmission, and/or may be an UL LP-WUS transmission, possibly using a given property. The indication may be a RACH or SR transmission instead of UL-WUS if the coverage is not above a configured threshold in LP mode or upon timing advance expiry. The indication may be in the form of a MAC CE, RRC message, UCI, and/or PUCCH, possibly if the WTRU is operating in MR mode (e.g., the first power saving configuration). In one implementation, the WTRU may ramp up the transmission power of the UL LP-WUS by following one or more configurations that may be defined and/or configured for the UL LP-WUS by the network. The WTRU may determine to switch to another power saving configuration in response to the UL LP-WUS transmission power having been ramped up to a threshold.

In one method, the WTRU may transmit an uplink low power signal (e.g., an UL LP-WUS) instead of uplink control information (e.g., SR, HARQ NACK, CSI), for example to replace PUCCH, and/or when an uplink MAC CE is triggered (e.g., BSR, PHR, and/or other control signaling).

While operating in the power saving configuration, the WTRU may transmit a request for scheduling using a low power signal (e.g., from the low power radio). The WTRU may select the transmission property and the partition for the UL LP-WUS as a function of the measured channels and/or CQI, the size of the arrived uplink data for transmission, and/or the data flow from which the data arrived. The WTRU may indicate a scheduling request as a function of LP-WUS transmission and resource selection (e.g., sequence and/or resource) of the UL LP-WUS, where the resource selection may provide grant dimensioning for a proper grant for the WTRU based on the channel conditions and the amount of data arrived at the WTRU.

The WTRU may trigger the transmission of a low power signal, possibly in lieu of a UCI, data, and/or control main radio transmission, if one or more of the following conditions may be met. The conditions may include operation in a subset of power saving configurations and/or operation modes (e.g., in the low activity and/or LP operation mode), which the WTRU may determine from broadcast signaling (e.g., information signaled in SI), reception of dedicated signaling (e.g., DCI or MAC CE), and/or reception of implicit signaling (e.g., DL LP-WUS, SSB, RS, or a property thereof). The WTRU may also determine that control resources (e.g., PUCCH) and/or data resources (e.g., PUSCH) are suspended in the active power saving configuration and/or operation mode. Transmission of a UL LP-WUS may also be triggered if a TA is not valid or a TA is needed.

Additional conditions may include the uplink transmission being performed on a serving cell within the list of cells configured for the power saving configuration and/or operation mode, or the serving cell belongs to the same timing advance group as the cell that has configured the resource or the cells for which the resource is configured as valid. The WTRU may also consider measured channel conditions being within a range, below, and/or above a configured threshold (e.g., RSRP>threshold). The WTRU may determine that a TA is valid if the measured channel conditions (e.g., RSRP) have not changed by more than a configured margin. A transmission may also be triggered based on the estimated and/or determined TA value being within a range, larger than, and/or less than a threshold. The TA may be estimated by the WTRU from a received downlink signal (e.g., a synchronization signal and/or an on-demand synchronization signal).

The WTRU may also trigger UL LP-WUS transmission based on uplink data arrival, possibly from a subset of data flows (e.g., those configured for the power saving configuration), such as based on the triggering of BSR, DSR, and/or SR, or the triggering of a procedure for the transmission of bursty data. The triggering may also be based on latency or remaining timer associated with the data being less than a configured threshold. The remaining time may be associated with the time remaining until a packet is discarded or until an associated discard timer expires.

The WTRU may determine that the network has activated cell DRX, and the remaining time until the next on-duration and/or active period for uplink is larger than a configured threshold, or simply that the WTRU is operating in the non-active period of the cell DRX period. The WTRU may determine that the network is in an energy saving state, determined from broadcast signaling, reception of activation signaling, and/or implicitly from a property of a received downlink signal (e.g., SSB, DL WUS, RS).

The uplink low power signal may indicate the type of uplink control information or control information (e.g., data arrival from a given data flow or group of flows, ACK, NACK, CSI, PMI), where such indication may be determined from a property of the signal (e.g., based on the resource, time and/or frequency occasion, and/or sequence used). A partition of different UL low power signal properties and/or resources may be used to indicate various control information types. In one example, UL LP-WUS may be used to convey SR, DSR, and/or BSR, where UL LP-WUS may be transmitted to start uplink communication and request a grant.

The uplink low power signal may indicate the type of grant needed. For example, the grant type may include one or more of: size, transport block size (TBS), modulation and coding scheme (MCS), repetition level, data arrival from a subset of data flows, and/or one or more physical properties of the grant (e.g., grant subcarrier spacing, grant duration), including a range, threshold, minimum, and/or maximum value. Such indication may be determined from a property of the signal, such as the resource used for transmission, a time and/or frequency occasion, and/or the sequence used to encode the signal. A partition of different uplink low power signal properties and/or resources may be used to indicate different control information types.

Following the transmission of a first uplink low power signal (e.g., to request a grant), the WTRU may monitor a response from the network either on the main radio (MR) or the low power (LP) radio. The monitoring behavior may be a function of the transmitted low power signal, the resource on which it was transmitted, the LP-WUS property, and/or the LP-WUS configuration or sub-configuration. The response on the main radio can be performed by monitoring the PDCCH and/or a CSI-RS or SSB signal. This may be done, for example, based on a timer (e.g., MR timer, C-DRX inactivity timer, or any C-DRX timer). The WTRU may be configured with a CSI reporting and/or measurement configuration to apply once the first UL low power signal is transmitted and/or once the response to it is received.

The response on the LP radio can be performed by monitoring a downlink LP-WUS and/or a LP-SS signal. The received downlink LP-WUS may indicate the type of grant to be used, the grant to activate, and/or a property of the grant type. For example, the DL LP-WUS may directly schedule a transmission grant, where a property of the DL LP-WUS indicates the grant type selected from a subset of grant types that are predefined and/or configured. In one example, a low-granularity time and/or frequency domain resource allocation table may be defined or configured, and the DL LP-WUS may point to an entry of that table. A sample table entry may include: transport block size x, time offset y (from reception of the LP-WUS), frequency or PRB allocation z, and/or bandwidth allocation zz. In another realization, the DL LP-WUS may simply activate the MR and instruct the WTRU to monitor PDCCH using the main radio, for example, by starting an MR timer or a C-DRX timer.

In a cell that supports multi-RAT spectrum sharing (MRSS), the UL LP-WUS may indicate whether the scheduling request is for a 5G or 6G resource. The UL LP-WUS may also indicate the type of uplink grant required, assuming different physical layer characteristics such as modulation and coding scheme, MCS range, subcarrier spacing, grant duration, bandwidth, frequency allocation, and/or carrier.

If the network is performing energy saving (e.g., through activation of cell DTX and/or cell DRX), the WTRU may transmit a UL LP-WUS to indicate a scheduling request or data arrival during a non-active period of cell DRX. Upon reception of a downlink LP-WUS indication (possibly derived from a given property or sub-configuration), the WTRU may temporarily suspend cell DTX, monitor PDCCH, and/or deactivate cell DTX. In some examples, the WTRU may start an MR timer or a C-DRX timer to monitor network scheduling activity following the reception of the LP-WUS, even if the WTRU is in the non-active period of cell DRX.

The WTRU may transmit a UL LP-WUS with a configured number of repetitions and/or a specific transmit power, which may be determined as a function of the measured channel conditions. For example, the number of repetitions and/or transmit power may be determined based on measured RSRP and/or based on the pathloss estimated from an LP-SS signal. The WTRU may determine the number of repetitions and/or transmit power based on the coverage or pathloss difference between the LP radio and the MR. For example, if the coverage difference is x dB, the WTRU may select a repetition number and/or transmit power that compensates for the x dB difference.

The WTRU may be identified by the network based on a property of the UL low power signal transmission or based on the use of a dedicated resource for transmitting the uplink low power signal. The WTRU may be configured with an LP-WUS property or a sub-configuration that enables identification of the WTRU in a given power saving configuration or operation mode. For example, the network may determine the identity of the WTRU based on the resource and/or sequence used to transmit the UL low power signal. In another realization, the WTRU may transmit a subsequent transmission (e.g., a main radio transmission, a PUCCH, and/or a MAC CE) to further identify itself and/or to indicate the type of uplink control information with greater granularity. In one example, following reception of a first UL low power signal, a second transmission may be used by the WTRU to provide identification and/or send UCI (e.g., with increased specificity). If separate UL LP-WUS resources are configured to correspond to specific TRPs or carriers, the WTRU may select a particular UL LP-WUS resource to indicate a scheduling request on a specific carrier, cell, and/or TRP. This may be applicable, for example, in contention-based scheduling requests or buffer status reports.

A UL LP-WUS resource selection procedure may be performed to evaluate whether UL LP-WUS transmission is required and whether cell DRX is activated for a given cell, carrier, bandwidth part, and/or TRP. For a TRP that is active (e.g., where cell DTX and/or DRX is deactivated), the network may indicate to the WTRU (e.g., using a first DL LP-WUS) a subset of allowed TRP and/or UL resources that can be used and/or woken up. The network may further indicate for each whether UL LP-WUS is required. When selecting a carrier or TRP, the WTRU may prioritize resources associated with cells and/or TRPs that are not operating under cell DRX, while also considering coverage conditions.

It should be understood that the UL LP-WUS may be a similar signal and/or sequence to that used by the MR for random access, scheduling requests, or various types of uplink control information. However, the UL LP-WUS is generated and transmitted by the low power radio (LR). For example, the UL LP-WUS may be a RACH signal using a similar PRACH sequence as used by the MR, but the signal is transmitted and received using the LR circuitry. In some realizations, however, a distinct UL channel and/or signal type and/or sequence may be defined specifically for UL LP-WUS purposes.

In one example realization, the WTRU may be configured and/or predefined with a mapping between an uplink low power signal property (or set of properties and/or resources) and a corresponding grant type. The grant type may be defined by one or more characteristics including: supported number of data bits (e.g., a minimum TBS value, a bit range, or a threshold), a modulation and coding scheme range, a repetition range, a physical layer attribute, and/or a coverage-related classification.

For example, a combination of parameters including the number of buffered bits, the data flows from which new uplink data has arrived, and the measured CQI and/or channel condition(s), may be used to select a specific uplink low power signal property and/or resource (e.g., LP-WUS property, LP-WUS transmission resource, LP-WUS configuration, and/or a desired MCS or MCS range).

For example, as shown in Table 1:

| | Measured channel | Selected LP-WUS |
|---|---|---|
| Data volume | conditions | property or resource |
| Between 0 and x1 | Between 0 and y1 | V1 |
| | Between y1 and y2 | V2 |
| Between x1 and x2 | Between 0 and y1 | V3 |
| | Between y1 and y2 | V4 |
| Between x2 and x3 | Between 0 and y1 | V5 |
| | Between y1 and y2 | V6 |

where x1, x2, x3, y1, y2, V1 . . . . V6 are configured, for example by dedicated RRC signaling or by broadcast signaling.

The WTRU may include a subsequent indication, for example as part of a second PUSCH transmission following the first UL LP-WUS transmission, if the received grant is not sufficient to transmit the buffered data, and/or if the received grant does not meet the necessary coverage level. The WTRU may determine the number of repetitions in the second PUSCH transmission as a function of the WTRU's coverage. For example, the WTRU may receive a grant that spans multiple transmission occasions and may select and/or indicate the number of repetitions to satisfy a required coverage level, such as a difference of x dB between low power and main radio downlink synchronization or broadcast signal measurements. The WTRU may also include finer granularity uplink control information or channel state information in the second transmission, including for example CQI, CSI reporting, buffer status reporting (BSR), and/or downlink scheduling request (DSR).

The network may indicate a downlink control message using a downlink low power signal, for example based on one or more properties of the LP-WUS signal. The LP-WUS signal may point to one of a plurality of configured values associated with a given configuration parameter. Alternatively, the DL low power signal may be used instead of a PDCCH to convey control information, for example in a multi-stage or staged decoding procedure.

A property of the DL LP-WUS signal may include, for example: the sequence used to transmit the signal, the LP-WUS configuration, the resource on which the signal is transmitted, the sequence offset, the time occasion at which the signal is transmitted, the carrier or bandwidth part used to transmit the signal, the transmission reception point (TRP) from which the signal is transmitted, and/or the frequency domain allocation of the signal.

The following parameters and/or control information types may be indicated as part of the DL LP-WUS signal: an indication of which BWP, carrier, TRP, or radio unit (RU) to assume for data or control reception or transmission; scheduling information; PDCCH monitoring time duration or offset; an indication of assumed or expected data size; activation of configured grant (CG) or semi-persistent scheduling (SPS); activation of MR mode operation or LP/inactive mode operation; an indication of 5G or 6G allocation, for example in a multi-RAT spectrum sharing (MRSS) cell; initiation or activation of an on-demand synchronization signal block (OD-SSB); or a request for channel state measurement or CSI reporting.

A property of scheduling information, such as an uplink grant or a downlink assignment, may be inferred from the received DL LP-WUS signal. The scheduling information may consist of, for example, a frequency domain allocation, a time allocation including a specific time instance and/or duration, a priority level, a modulation and coding scheme (MCS), a transport block size (TBS), a number of spatial layers, a number of transport blocks to be transmitted, a transmission configuration indicator (TCI) state or a sounding reference signal resource indicator (SRI), a repetition level, and an indication of whether the grant is a configured grant type 1 (where the WTRU immediately uses the configured UL resources upon receiving the configuration), a configured grant type 2 (where the WTRU waits for an explicit MAC CE before using the configured UL resources), or a dynamic grant.

An indication by LP-WUS may consist of at least one of the following: an explicit indication by a field included in the LP-WUS or by the RNTI or configuration used to mask the LP-WUS signal; or an implicit indication determined by the WTRU based on one or more properties of the LP-WUS signal, such as its format, size, or the resource used to transmit it (e.g. time and/or frequency occasion), where the mapping between the property and the value may be configured or signaled by RRC or MAC.

In some examples, a bursty data exchange may be provided while the WTRU operates in a “Inactive/LP mode operation” power saving configuration. A scheduling request may be made as a function of a low power wake-up signal (LP-WUS) transmission and the selection of a signal resource or sequence, where the selection provides dimensional guidance for the uplink grant.

In one example, the following procedure may be performed. First, the WTRU determines that the serving cell is operating in power saving configuration x, based on reception of explicit signaling or implicitly from the type of access or received RS/SSS signals. Following that, the WTRU transmits a UL LP-WUS. Upon reception of a confirmation signal from the network, such as a DCI or DL LP-WUS, the WTRU performs a data transmission. Intermediate steps may also be present.

The WTRU may be configured with one or more power saving configurations, under which it can request an uplink data transmission grant by transmitting a UL low power signal, for example, a UL LP-WUS. The WTRU determines that the serving cell is operating under a specific power saving configuration, which can be identified through explicit signaling, such as system information (SI), PBCH, DCI, MAC CE, or via a received DL LP-WUS that indicates the activation or application of the power saving configuration. Alternatively, this determination may be made implicitly based on the type of access or by detecting a reference signal or synchronization signal such as RS or SSS.

The WTRU may be configured with a plurality of properties associated with a low power signal, each of which can be used to indicate to the network a scheduling request. A given property may include, for example, the time occasion of the transmission, the frequency allocation of the transmission (such as PRB, BWP, or carrier), a subgroup associated with the low power signal, a sequency type or length used to encode the signal, and/or a sequency or RNTI used to scramble the signal or identify the WTRU.

In addition, the WTRU may be configured with a plurality of partitions for the UL low power signal, where each partition is defined by one or more low power signal properties. Each partition may be used to request a grant of a particular size (for example, a minimum size or a defined range), indicate a coverage or channel measurement level or range (such as an RSRP range or RSRP value being less than a configured threshold), indicate a measured CSI or CQI level or range, and/or indicate that data has arrived for one or more data flows.

When uplink data arrives at the WTRU buffer, it may trigger a buffer status report (BSR) or scheduling request (SR). While the WTRU is operating in the power saving configuration, it transmits the scheduling request using a low power signal, such as from the low power radio.

The WTRU may select the specific transmission property and the associated partition for the UL LP-WUS based on its measured channel quality indicators, such as CQI, the size of the arrived uplink data intended for transmission, and/or the specific data flow from which the data arrived.

Following the LP-WUS transmission, the WTRU receives a grant for uplink transmission, a timing advance, and/or an acknowledgment to proceed with data transmission. The WTRU transmits uplink data on the grant received or on a configured grant.

This process may be generalized to enable the WTRU to determine its operation within the identified power saving configuration. A relevant condition may be signaled or inferred. For example, a control channel or broadcast channel may provide information on how the cell presents itself—this may include signaling similar to network energy savings (NES) activation, or other information that may be WTRU-specific or common across WTRUs. Different arrangements may be configured per device type or access mechanism, for example, in system information (SI).

In response to an uplink data arrival condition, the WTRU may transmit a low power uplink signal (e.g. UL-WUS) instead of a scheduling request or random access procedure to request transmission on a configured uplink resource (e.g. OFDM-based) or to request a grant. If the WTRU is not time-aligned, it may transmit a UL LP-WUS sequence based on downlink synchronization, and in a subsequent OFDM transmission, it may refine its uplink timing. A downlink indication may provide a timing advance correction to apply for the main radio transmission, or the timing advance may be estimated by the WTRU based on received downlink signals such as an SSB or a low power signal. The WTRU may transmit the UL LP-WUS using a given configuration or subgroup as a function of the timing advance validity, the estimated timing from the received downlink synchronization signal, whether it requires an uplink grant or intends to transmit on a configured PUSCH resource, the WTRU's measured coverage or channel conditions, and/or the size of the buffered data or burst intended for transmission. The WTRU may determine the transmit power of the UL LP-WUS based on a downlink pathloss estimate or may transmit the signal according to a configured target transmission power.

Coverage and the amount of data for transmission may be indicated by the UL LP-WUS resource or subconfiguration, allowing the network to provide an appropriate grant. For certain types of low power wide-area (LPWA) devices, the first transmission may be simplified, and resource selection may convey only coverage information. In the case of a scheduling request, a dedicated resource may be allocated to the WTRU. The resource selection or sequence may be used to inform the network of grant requirements. This can be used for low granularity CSI or coverage indication. The assumptions used for each low power signal indication may include the size of the data burst, the coverage condition, or both. The logic for selection of the UL LP-WUS property or subconfiguration may take into account these assumptions. A maximum burst size may be defined per UL LP-WUS scheduling request transmission. The WTRU may also perform power ramping or repetition increase for the low power signal based on configured parameters or channel conditions.

The WTRU may transmit data on a configured PUSCH resource following the UL LP-WUS transmission or reception of a reply (e.g. ACK, DCI, timing advance command, or DL LP-WUS). The WTRU may temporarily activate the main radio to exchange data and then return to the low power operation configuration after completing the exchange. The WTRU may switch to main radio operation if it indicates the presence of subsequent data to transmit, or if no uplink resource is available. For example, a buffer status report may be multiplexed with the transmission, a second UL LP-WUS configuration or subgroup may indicate additional data, or an instruction may be received. In such cases, the data may be exchanged using dynamic uplink grants, and the PDCCH monitoring period may be governed by a timer.

The WTRU may condition data transmission on being within a list of cells identified by a configured area RNTI or having a valid timing advance. This may allow reuse of security context, uplink PUSCH resources, and other configuration parameters across a group of cells sharing the same configuration. The WTRU may return to the low power operation mode upon expiry of a configured timer, completion of the data transmission that triggered the UL LP-WUS, or the absence of subsequent buffer status reports.

If a downlink LP-WUS is received on a first configuration or subgroup, the WTRU may monitor a configured PDSCH resource for downlink data reception. The WTRU may activate the main radio temporarily to receive the data and then return to the low power configuration once the reception is complete, without PDCCH monitoring. The WTRU may monitor the PDCCH (e.g. switch to main radio operation) if it receives a downlink LP-WUS on a second configuration or subgroup, or if an indication is received that subsequent downlink data will follow (e.g. via the PDSCH). The PDCCH monitoring period may be governed by a new timer.

In some examples, this implies different behavior by the WTRU based on the group or configuration of the received downlink LP-WUS. For example, reception of a downlink LP-WUS on a first group or configuration may indicate a one-shot data reception, after which both the WTRU and the network may return to a power saving state. Reception of a downlink LP-WUS on a second group or configuration may indicate that the network intends to schedule multiple downlink assignments, or that additional uplink or downlink data will follow the initial transmission.

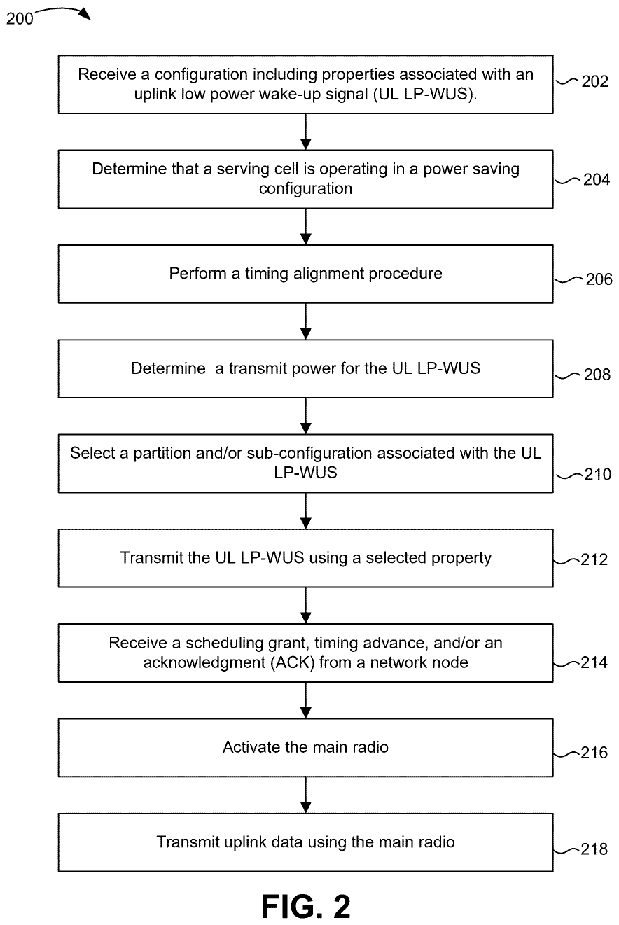

Referring now to FIG. 2, a method 200 for uplink data transmission by a wireless transmit/receive unit (WTRU) operating in a power saving configuration is illustratively depicted.

The method may support efficient uplink transmission while the WTRU operates in a reduced activity mode, without requiring a full RRC state transition or a traditional random access procedure, and may minimize signaling and energy consumption.

At 202, the WTRU may receive a configuration comprising one or more properties associated with an uplink low power wake-up signal (UL LP-WUS). The configuration may be received via dedicated signaling or broadcast signaling and may include, for example, a time occasion, frequency allocation, transmission sequence, and/or a subgroup. The WTRU may be configured with a plurality of UL LP-WUS properties or partitions, each of which may correspond to different scheduling characteristics, such as a minimum data size, a coverage threshold, or a channel measurement range.

At 204, the WTRU may determine that a serving cell is operating in a power saving configuration. This determination may be based on the reception of explicit signaling, such as system information (SI), a physical broadcast channel (PBCH), downlink control information (DCI), a medium access control control element (MAC CE), and/or a downlink low power wake-up signal (DL LP-WUS). In some examples, the determination may be based on the type of received access signal or on a synchronization signal associated with power saving operation.

At 206, the WTRU may perform a timing alignment procedure (e.g., prior to uplink transmission). For example, if the WTRU is not time-aligned, it may estimate an uplink timing advance based on the reception of a downlink synchronization signal (e.g., a synchronization signal block (SSB) or a low power synchronization signal), and may refine its uplink transmission timing in a subsequent transmission. Alternatively or additionally, the WTRU may receive a timing advance correction in response to the UL LP-WUS transmission.

At 208, the WTRU may determine a transmit power for the UL LP-WUS. The transmit power may be selected based on a downlink pathloss estimate from a received downlink signal and/or may be set according to a configured target transmission power. In one example, the WTRU may determine a number of repetitions for the UL LP-WUS transmission as a function of a measured channel condition (e.g., RSRP or pathloss). A higher number of repetitions may be selected if coverage conditions fall below a configured threshold.

At 210, the WTRU may select a partition and/or sub-configuration associated with the UL LP-WUS. The selected partition may correspond to a threshold or range of one or more of a buffered data size, channel condition, or coverage level. The partition selection may be determined based on a measured condition and/or an associated data flow. In one example, the partition may correspond to a predefined mapping to a specific grant dimension or uplink resource.

At 212, the WTRU may transmit the UL LP-WUS using a selected one of the one or more properties indicated in the configuration. The selected property may include, for example, a time-frequency resource, a sequence, and/or a subgroup. The UL LP-WUS transmission may function as a scheduling request and/or may indicate one or more of a data volume, a coverage condition, or a channel measurement condition. The UL LP-WUS may be transmitted using a low power radio or may leverage a low duty-cycle operation of the main radio.

At 214, the WTRU may receive, in response to the UL LP-WUS, one or more of a scheduling grant, timing advance, and/or an acknowledgment (ACK) from a network node. The response may be received on the main radio and/or a low power receiver, depending on the configuration. The received information may be used to determine uplink transmission parameters for the subsequent main radio transmission.

The scheduling grant (e.g., transmitted in response to the UL LP-WUS) may be received using either the low-power radio or the main radio. For example, the WTRU may monitor for a downlink control message using the low-power radio or may activate the main radio to receive the scheduling grant. The determination of which radio to use may depend on the configuration, the current power saving mode, or a property of the UL LP-WUS.

At 216, the WTRU may activate the main radio based on the response and/or the UL LP-WUS configuration. The activation may be temporary and may be used for transmitting data, receiving control signaling, or responding to network instructions. In one realization, the WTRU may activate the main radio if a configured condition is met, such as the reception of an ACK or grant, or if a second UL LP-WUS configuration indicates a request for persistent connectivity.

In some examples, the configuration received by the WTRU may comprise information associated with a plurality of partitions. Each partition may be associated with one or more conditions used for selection and transmission of the UL LP-WUS. For example, a partition may be defined based on a minimum size or a size range associated with uplink data buffered at the WTRU.

Additionally, and/or alternatively, a partition may correspond to a reference signal received power (RSRP) range or a condition that the RSRP is less than a configured threshold. In further examples, a partition may correspond to a level or range of measured channel state information (CSI) or channel quality indicator (CQI). A partition may also be associated with one or more data flows. The WTRU may be configured to select a partition from the plurality of partitions and to transmit the UL LP-WUS based on the selected partition. The selected partition may guide the transmission of the UL LP-WUS using a property that reflects one or more of the associated conditions, enabling the network to determine an appropriate uplink scheduling grant.

At 218, the WTRU may transmit uplink data using the main radio on a configured or dynamically scheduled resource. The uplink data may include bursty data, control information, or other traffic, and the transmission may be performed in accordance with the received scheduling information. Following the transmission, the WTRU may revert to a power saving configuration, for example based on a timer expiration, buffer status, or absence of a subsequent data scheduling request.

1. A wireless transmit/receive unit (WTRU) comprising:
one or more transceivers; and
a processor configured to:
receive a configuration, wherein the configuration comprises one or more properties associated with an uplink low power wake-up signal (UL LP-WUS);
determine that a serving cell is operating in a power saving configuration;
transmit, via the low-power radio, the UL LP-WUS using a selected property of the one or more properties indicated in the configuration, wherein the UL LP-WUS indicates one or more of a scheduling request, a volume of uplink data, a coverage condition, or a channel measurement condition;
receive, in response to the UL LP-WUS, one or more of a scheduling grant or timing advance information; and
send uplink data based on one or more of the scheduling grant or the timing advance information.

2. The WTRU of claim 1, wherein the one or more transceivers comprises a low power radio and a main radio, wherein the UL LP-WUS is transmitted by the low power radio, and wherein the processor is configured to receive the configuration via dedicated signaling or broadcast signaling.

3. The WTRU of claim 1, wherein the processor is configured to determine that the serving cell is operating in the power saving configuration based on reception of one or more of system information, a physical broadcast channel (PBCH), downlink control information (DCI), a medium access control (MAC) control element (CE), or a downlink low power wake-up signal (DL LP-WUS).

4. The WTRU of claim 1, wherein the one or more properties comprise any combination of a time occasion associated with the UL LP-WUS, a frequency allocation associated with the UL LP-WUS, a subgroup associated with the UL LP-WUS, a sequence type or length associated with encoding of the UL LP-WUS, or a sequence or radio network temporary identifier (RNTI) used to scramble the UL LP-WUS.

5. The WTRU of claim 1, wherein the processor is configured to select the selected property as a function of one or more of a measured channel condition, a size of the uplink data, or a data flow associated with the uplink data.

6. The WTRU of claim 2, wherein the processor is configured to transmit the UL LP-WUS using a transmit power based on a downlink pathloss estimate;
wherein the downlink pathloss estimate is determined based on reception of one or more of a downlink synchronization signal, a low power synchronization signal, an on-demand signal, or a cell discovery signal; and
wherein the UL LP-WUS comprises a signal transmitted by reflecting or modulating a downlink signal received by the low-power radio.

7. The WTRU of claim 1, wherein the processor is configured to temporarily activate a main radio for transmission of the uplink data and return to a power saving configuration after transmission of the uplink data is complete.

8. The WTRU of claim 1, wherein the uplink data is sent using a configured or dynamically scheduled resource; and
wherein the configured or dynamically scheduled resource is valid for a cell that shares one or more of a configuration area or timing advance group with the serving cell.

9. The WTRU of claim 1, wherein the configuration comprises a plurality of power saving configurations, and the processor is configured to select one of the configurations based on one or more of a volume of the uplink data, a latency associated with the uplink data, or a timing advance validity condition.

10. The WTRU of claim 1, wherein the configuration comprises one or more of:
information about a plurality of partitions, wherein each partition is associated with a minimum size or a size range associated with uplink data;
a reference signal received power (RSRP) range or a condition that the RSRP is less than a configured threshold;
a level or range of measured channel state information (CSI) or channel quality indicator (CQI); or
one or more data flows; and
wherein the processor is configured to send the UL LP-WUS based on a partition of the plurality of partitions.

11. A method implemented by a wireless transmit/receive unit (WTRU), the method comprising:
receiving a configuration, wherein the configuration comprises one or more properties associated with an uplink low power wake-up signal (UL LP-WUS);
determining that a serving cell is operating in a power saving configuration;
sending, via the low-power radio, the UL LP-WUS using a selected property of the one or more properties indicated in the configuration,
wherein the UL LP-WUS indicates one or more of a scheduling request, a volume of uplink data, a coverage condition, or a channel measurement condition;
receiving, in response to the UL LP-WUS, one or more of a scheduling grant or timing advance information; and
sending uplink data based on one or more of the scheduling grant or the timing advance information.

12. The method of claim 11, further comprising receiving the configuration via dedicated signaling or broadcast signaling.

13. The method of claim 11, wherein determining that the serving cell is operating in the power saving configuration comprises detecting one or more of system information, a physical broadcast channel (PBCH), downlink control information (DCI), a medium access control (MAC) control element (CE), or a downlink low power wake-up signal (DL LP-WUS).

14. The method of claim 11, wherein the one or more properties comprise any combination of a time occasion associated with the UL LP-WUS, a frequency allocation associated with the UL LP-WUS, a subgroup associated with the UL LP-WUS, a sequence type or length associated with encoding of the UL LP-WUS, or a sequence or radio network temporary identifier (RNTI) used to scramble the UL LP-WUS.

15. The method of claim 11, wherein the selected property is selected as a function of one or more of a measured channel condition, a size of the uplink data, or a data flow associated with the uplink data.

16. The method of claim 11, comprising:
sending the UL LP-WUS using a transmit power based on a downlink pathloss estimate, wherein the downlink pathloss estimate is determined based on reception of one or more of a downlink synchronization signal, a low power synchronization signal, an on-demand signal, or a cell discovery signal; and
wherein the UL LP-WUS comprises a signal transmitted by reflecting or modulating a downlink signal received by a low-power radio.

17. The method of claim 11, comprising:
temporarily activating a main radio for sending the uplink data; and
returning to a power saving configuration after the sending of the uplink data is complete.

18. The method of claim 11, wherein the uplink data is sent using a configured or dynamically scheduled resource; and
wherein the configured or dynamically scheduled resource is valid for a cell that shares one or more of a configuration area or timing advance group with the serving cell.

19. The method of claim 11, wherein the configuration comprises a plurality of power saving configurations, and the method comprises selecting one of the configurations based on one or more of a volume of the uplink data, a latency associated with the uplink data, or a timing advance validity condition.

20. The method of claim 11, wherein the configuration comprises one or more of:
information about a plurality of partitions, wherein each partition is associated with a minimum size or a size range associated with uplink data;
a reference signal received power (RSRP) range or a condition that the RSRP is less than a configured threshold;
a level or range of measured channel state information (CSI) or channel quality indicator (CQI); or
one or more data flows; and
wherein the method comprises selecting a partition of the plurality of partitions and sending the UL LP-WUS based on the selected partition.
